(19) United States
(12) Patent Application Publication
(10) Pub. No.: US 2026/0120289 A1
(43) Pub. Date: Apr. 30, 2026

(54) MODEL PROCESSING, AND PORTRAIT GENERATION

(71) Applicant: MASHANG CONSUMER FINANCE CO., LTD., Chongqing (CN)

(72) Inventor: Sheng CHEN, Chongqing (CN)

(73) Assignee: MASHANG CONSUMER FINANCE CO., LTD., Chongqing (CN)

(21) Appl. No.: 19/344,309

(22) Filed: Sep. 29, 2025

(30) Foreign Application Priority Data
Oct. 30, 2024 (CN) 202411539072.3

(51) Int. Cl. G06T 7/11; G06T 3/40; G06T 7/194; G06T 11/00; G06V 10/40; G06V 10/774; G06V 10/82; G06V 40/16

(52) U.S. Cl. CPC G06T 7/11; G06T 3/40; G06T 7/194; G06T 11/00; G06V 10/40; G06V 10/774; G06V 10/82; G06V 40/168; G06T 2207/20081; G06T 2207/20084; G06T 2207/30201

(57) ABSTRACT

A model processing method includes: obtaining a sample data set of a sample subject including a sample image, a sample reference image, and a sample portrait; inputting the sample data set into a neural network model for image processing to obtain a predicted portrait, where the image processing includes: performing feature extraction on the sample image and the sample reference image to obtain facial and hairstyle features of the sample subject; generating a reference portrait of the sample subject based on the facial and hairstyle features; determining a sample portrait feature based on the reference portrait and the facial and hairstyle features; and generating the predicted portrait based on the sample portrait feature; and adjusting parameters of the neural network model based on the sample image, the predicted portrait, the sample portrait and the reference portrait.

### CROSS-REFERENCE TO RELATED APPLICATION

The present application claims priority to and the benefit of Chinese Patent Application No. 202411539072.3, filed on Oct. 30, 2024, the disclosure of which is incorporated herein by reference in its entirety.

### TECHNICAL FIELD

The present application relates to artificial intelligence and image processing technologies, and more particularly, to model processing, and portrait generation.

### BACKGROUND

Subject image segmentation is a hot topic in image processing. It is a classic task of the subject image segmentation to distinguish the subject from the background at the pixel level, which has a broad range of applications. Generally, subject image segmentation tasks may be divided into the following two categories: segmentation of full-body subject images and half-body subject images, referred to as general subject image segmentation; and segmentation of half-body subject images, referred to as portrait segmentation. The portrait segmentation technology is widely deployed on the Internet, mobile phones and edge devices, and thus requires both segmentation accuracy and fast inference speed. In the case where the edge of the subject in the subject image is complex and fast-changing, how to ensure both segmentation accuracy and segmentation speed in the subject image segmentation is still a challenge.

### SUMMARY

In an aspect, some embodiments of the present application provide a model processing method including: obtaining a sample data set of a sample subject, where the sample data set includes a sample image, a sample reference image, and a sample portrait, the sample reference image includes a background region image, a face region image, and a hairstyle region image, and the sample image is obtained by removing the hairstyle region image from the sample reference image; inputting the sample data set into a first neural network model for image processing to obtain a predicted portrait of the sample subject, where the image processing includes: performing feature extraction on the sample image and the sample reference image to obtain a first facial feature and a first hairstyle feature of the sample subject; generating a reference portrait of the sample subject based on the first facial feature and the first hairstyle feature; determining a sample portrait feature of the sample subject based on the reference portrait, the first facial feature, and the first hairstyle feature; and generating the predicted portrait based on the sample portrait feature; and adjusting model parameters of the first neural network model based on the sample image, the predicted portrait, the sample portrait, and the reference portrait to obtain a second neural network model.

In another aspect, some embodiments of the present application provide a portrait generation method including: obtaining an image data set of a first subject, where the image data set includes a first image and a first reference image, the first reference image includes a background region image, a face region image, and a hairstyle region image, and the first image is obtained by removing the hairstyle region image from the first reference image; and inputting the image data set into a second neural network model for image processing to obtain a portrait of the first subject, where the image processing includes: performing feature extraction on the first image and the first reference image to obtain a facial feature and a hairstyle feature of the first subject; determining a portrait feature of the first subject based on the facial feature and the hairstyle feature; and generating the portrait of the first subject based on the portrait feature.

In yet another aspect, some embodiments of the present application provide a model processing apparatus including: a first obtaining module, configured to obtain a sample data set of a sample subject, where the sample data set includes a sample image, a sample reference image, and a sample portrait, the sample reference image includes a background region image, a face region image, and a hairstyle region image, and the sample image is obtained by removing the hairstyle region image from the sample reference image; a first processing module, configured to input the sample data set into a first neural network model for image processing to obtain a predicted portrait of the sample subject, where the image processing includes: performing feature extraction on the sample image and the sample reference image to obtain a first facial feature and a first hairstyle feature of the sample subject; generating a reference portrait of the sample subject based on the first facial feature and the first hairstyle feature; determining a sample portrait feature of the sample subject based on the reference portrait, the first facial feature, and the first hairstyle feature; and generating the predicted portrait based on the sample portrait feature; and a model training module, configured to adjust model parameters of the first neural network model based on the sample image, the predicted portrait, the sample portrait, and the reference portrait to obtain a second neural network model.

In yet another aspect, some embodiments of the present application provide a portrait generation apparatus including: a second obtaining module, configured to obtain an image data set of a first subject, where the image data set includes a first image and a first reference image, the first reference image includes a background region image, a face region image, and a hairstyle region image, and the first image is obtained by removing the hairstyle region image from the first reference image; and a second processing module, configured to input the image data set into a second neural network model for image processing to obtain a portrait of the first subject, where the image processing includes: performing feature extraction on the first image and the first reference image to obtain a facial feature and a hairstyle feature of the first subject; determining a portrait feature of the first subject based on the facial feature and the hairstyle feature; and generating the portrait of the first subject based on the portrait feature.

In yet another aspect, some embodiments of the present application provide an electronic device including a processor and a memory storing a computer program executable by the processor to perform the model processing method described above or the portrait generation method described above.

In still another aspect, some embodiments of the present application provide a non-transitory computer-readable storage medium storing a computer program executable by a processor to perform the model processing method described above or the portrait generation method described above.

In still another aspect, some embodiments of the present application provide a computer program product including a computer program executable by a processor to perform the model processing method described above or the portrait generation method described above.

### BRIEF DESCRIPTION OF THE DRAWINGS

FIG. 1 is a schematic block diagram illustrating the technical concept of a model processing method and a portrait generation method according to some embodiments of the present application.

FIG. 2 is a schematic block diagram of a U-Net model according to some embodiments of the present application.

FIG. 3 is a schematic flowchart of a model processing method according to some embodiments of the present application.

FIG. 4 is a schematic flowchart of a model processing method according to some embodiments of the present application.

FIG. 5 is a schematic block diagram illustrating a method of training a portrait generation model according to some embodiments of the present application.

FIG. 6 is a schematic block diagram illustrating a method of training a portrait generation model according to some embodiments of the present application.

FIG. 7 is a schematic flowchart of a portrait generation method according to some embodiments of the present application.

FIG. 8 is a schematic block diagram illustrating a portrait generation method according to some embodiments of the present application.

FIG. 9 is a schematic block diagram illustrating a portrait generation method according to some embodiments of the present application.

FIG. 10 is a schematic block diagram of a model processing apparatus according to some embodiments of the present application.

FIG. 11 is a schematic block diagram of a portrait generation apparatus according to some embodiments of the present application.

FIG. 12 is a schematic block diagram of an electronic device according to some embodiments of the present application.

### DETAILED DESCRIPTION

Some embodiments of the present application provide a model processing method, a portrait generation method and related apparatuses, to solve the problem in the related art that the portrait obtained by segmentation of the subject image is unnatural and unclear due to its unnatural edges and low clarity.

Some embodiments of the present application will be described in detail below with reference to the accompanying drawings. The embodiments are described for illustrative purposes only and are not intended to limit the present application.

In the field of portrait segmentation, the portrait is usually segmented from a subject image by using a matting technique, and a major drawback of the matting technique is the presence of blurred and discontinuous edges, resulting in a lack of natural feeling of the segmented portrait. To this end, the conventional method incorporates a background image as reference and utilizes a deep neural network to train the portrait segmentation model. Specifically, in the process of training the portrait segmentation model, both the segmentation output result of the portrait segmentation model and the background image are used as reference information for model training, and a Context Switching block (CS) module is introduced to effectively select useful information from the image, and after decoding by a decoder, a more accurate matting result is obtained. However, although this method optimizes the quality of the segmented portrait to some extent, such as enhancing contour smoothness of the segmented portrait, this method still belongs to a matting technique in nature. Thus, considering the defects of the matting technique, the segmented portraits still retain more or less residual background pixel information, leading to edges that are still not fully natural or continuous and the low definition.

To solve the technical problem that portrait segmentation is not natural and smooth, and the definition is low, an embodiment of the present application provides a model processing method. A sample data set of a sample subject is obtained, where the sample data set includes a sample image, a sample reference image, and a sample portrait, and the sample reference image includes a background region image, a face region image, and a hairstyle region image; the sample data set is input into a first neural network model; and feature extraction is performed on the sample image and the sample reference image to obtain a facial feature and a hairstyle feature of the sample subject. It can be seen that during model training, the used sample data includes not only the sample reference image (i.e., a complete portrait), but also the sample image with the hairstyle region image removed (i.e., including only the background region image and a face region image). Therefore, accurate and rich hairstyle features, i.e., a hairstyle semantic structure may be extracted in the model training, rather than in simple hairstyle contour recognition. This provides strong semantic structural support for the model training. Further, a reference portrait of the sample subject is generated based on the facial feature and the hairstyle feature; a portrait feature of the sample subject is determined based on the reference portrait, the facial feature, and the hairstyle feature; a predicted portrait of the sample subject is generated based on the portrait feature; and model parameters of the first neural network model are adjusted based on the sample image, the predicted portrait, the sample portrait, and the reference portrait to obtain a second neural network model. Since the sample reference image provides accurate and rich hairstyle features for the model training, and the sample image provides accurate and rich facial features for the model training, iterative training of the model enables the generated predicted portrait to have a clear and natural hairstyle semantic structure and a clear and natural face semantic structure, and further enables the trained second neural network model to have the capability to generate a clear and natural portrait.

Both the model processing method and the portrait generation method according to an embodiment of the present application may be executed by an electronic device, or may be executed by software installed in the electronic device. Specifically, the electronic device may be a terminal device or a server device. The terminal device may include a smartphone, a notebook computer, an intelligent wearable device, an in-vehicle terminal, and the like. The server device may include an independent physical server, a server cluster including a plurality of servers, or a cloud server configured to perform cloud computing.

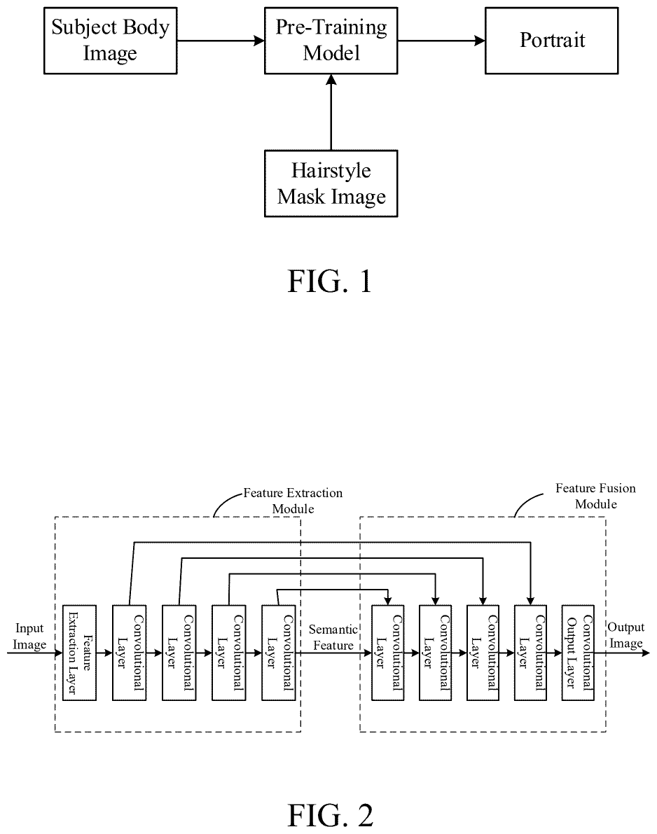

FIG. 1 is a schematic diagram of a technical concept of a model processing method and a portrait generation method according to some embodiments of the present application. As shown in FIG. 1, during model training or during portrait generation, a subject body image and a hairstyle mask image are input to a pre-training model. The pre-training model generates a portrait based on the subject body image and the hairstyle mask image. The subject body image refers to an image including a hairstyle region image, a face region image, and a background region image. The hairstyle mask image refers to an image obtained by performing mask processing on the hairstyle region image in the subject body image. That is, the pre-training model may obtain all features of the subject body (including a hairstyle feature, a facial feature, and a background feature) based on the subject body image, a facial feature and a background feature may be obtained based on the hairstyle mask image, an accurate facial feature and a hairstyle feature are determined by using all features of the subject body as reference features, and then a portrait is generated based on the facial feature and the hairstyle feature. In the model training method, the pre-training model may be a U-Net (a U-shaped network architecture) model. In the portrait generation method, the pre-training model may be a portrait generation model trained based on the U-Net model. It can be seen that both the model processing method and the portrait generation method in an embodiment of the present application generate a portrait based on the accurate facial feature and the hairstyle feature, that is, the portrait is obtained based on the generation method, rather than the matting technique, so that the generated portrait has both a clear and natural hairstyle semantic structure and a clear and natural face semantic structure.

Before describing the model processing method in detail, the pre-training model used in processing the model in an embodiment of the present application, that is, the U-Net model, is first described. FIG. 2 is a schematic block diagram of a U-Net model according to some embodiments of the present application. As shown in FIG. 2, the U-Net model adopts a U-shaped architecture, including a feature extraction network (i.e., encoder) on the left and a feature fusion network (i.e., decoder) on the right. The feature extraction network serves as a down-sampling layer, and is configured to encode a high-resolution image as an abstract semantic feature. The feature extraction network is formed by one feature extraction layer and four convolution layers. The feature fusion network serves as an up-sampling layer, and is configured to decode the abstract semantic feature encoded by the feature extraction network to obtain a high-resolution image. The feature fusion network is formed by four convolutional layers and one convolutional output layer. The four convolutional layers in the feature fusion network correspond to the four convolutional layers in the feature extraction network, and each convolutional layer in the up-sampling layer fuses the output features of the corresponding convolutional layer in the down-sampling layer, so that the image information output by the up-sampling layer is more comprehensive and more complete. The convolution output layer is configured to perform dimensionality reduction processing on the image information from the up-sampling layer, that is, to reduce the number of channels to a specific number, so as to obtain a target image. The number of convolutional layers in the feature extraction network and the feature fusion network is not limited to four, as long as the number of convolutional layers in the feature extraction network is same as that of the feature fusion network. Four convolutional layers in an embodiment are described as an example.

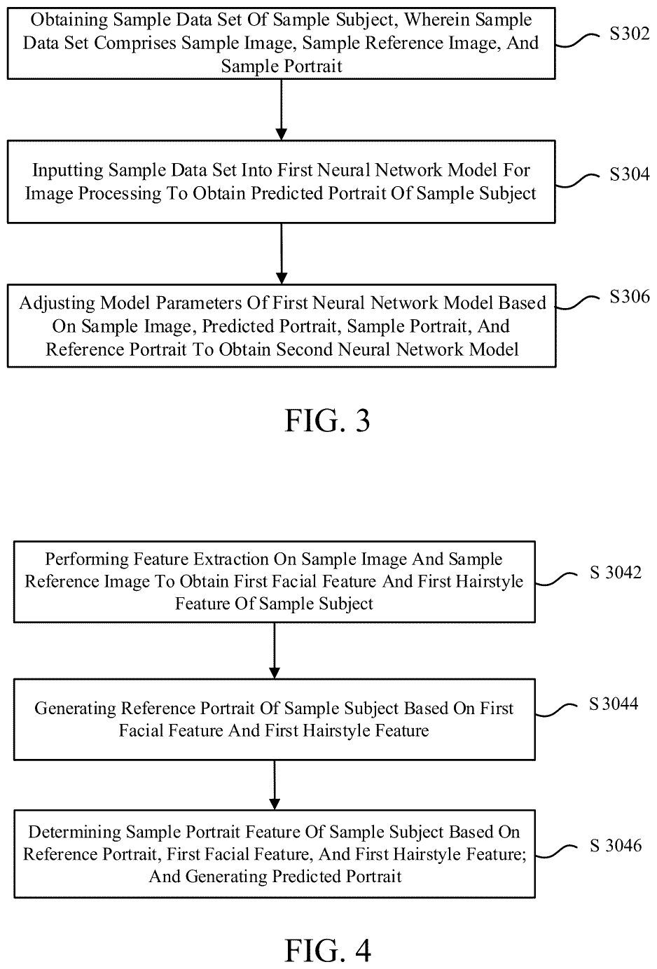

FIG. 3 is a schematic flowchart of a model processing method according to some embodiments of the present application. As shown in FIG. 3, the method includes Step S302 to Step S306.

At Step S302, a sample data set for a sample subject is obtained, and the sample data set includes a sample image, a sample reference image, and a sample portrait.

The sample reference image includes a background region image, a face region image, and a hairstyle region image. The sample image is obtained by removing the hairstyle region image from the sample reference image, and the sample image includes the face region image and the background region image. The sample portrait refers to an image without the background region image, and the sample portrait includes a face region image and a hairstyle region image.

For example, a sample subject is a user A, and a photograph of the user A includes a half-body portrait of the user A and a background region image, and the half-body portrait includes a face region image and a hairstyle region image of the user A. Then, this photograph of the user A is the sample reference image. A resulting photograph lacking the hairstyle region image, obtained by removing (e.g., by masking or by erasing using an electronic erasure) the hairstyle region image from the photograph of the user A, is the sample image. A resulting photograph lacking the background region image, obtained by removing the background region image (or by extracting a foreground image) from the photograph of the user A, is the sample portrait including the face region image and the hairstyle region image of the user A.

During the obtaining of the sample data set, a plurality of sample reference images for the sample subject in different postures may be obtained first. Then the foreground image is extracted from each sample reference image by using a foreground extraction algorithm to obtain the sample portrait. The foreground image includes the face region image and the hairstyle region image. The sample portrait is the foreground image in the sample reference image. The foreground image may be extracted by using any existing foreground extraction algorithm. For example, a mask technique is used to matte the sample reference image to obtain the foreground image. For each sample reference image, the hairstyle region image is recognized in the sample reference image, and a mask processing is performed on the hairstyle region image in the sample reference image to obtain the sample image. Alternatively, the sample image may be obtained by directly erasing the hairstyle region image from the sample reference image.

For example, for the same sample subject, five sample reference images for the sample subject in different poses are obtained. Then a copy is replicated for each sample reference image to obtain a replicated sample reference image. The masking process is performed on the hairstyle region image in each of the replicated sample reference images, so that sample images respectively corresponding to the five sample reference images are obtained.

In the sample data set, the plurality of sample reference images with the different poses share the same identification (i.e., ID) feature. That is, the same ID corresponds to a plurality of sample reference images and a plurality of sample images. In the model training process, the plurality of sample reference images and the plurality of sample images corresponding to the same ID are used as input data, so that the diversity of the input data may be increased, the information learned by the model is more comprehensive and more diversified, and the model training may be faster.

At Step S304, the sample data set is input into a first neural network model for image processing to obtain a predicted portrait of the sample subject.

The image processing includes Step S3042 to Step S3046 as shown in FIG. 4.

At Step S3042, feature extraction is performed on the sample image and the sample reference image to obtain a first face feature and a first hairstyle feature of the sample subject.

Alternatively, the first neural network model includes a first feature extraction module and a second feature extraction module. The first neural network model is a portrait generation model to be trained. After the sample data set is input into the portrait generation model to be trained, feature extraction is first performed by the first feature extraction module and the second feature extraction module. The first feature extraction module performs feature extraction on the sample image to obtain a first facial feature of the sample subject, the second feature extraction module performs feature extraction on the sample reference image to obtain a reference image feature of the sample subject, and the reference image feature is input to the first feature extraction module. The first facial feature and the reference image feature are processed through the first feature extraction module to obtain a first hairstyle feature. That is, the first neural network model (i.e., the portrait generation model to be trained) includes two feature extraction modules having the same structure as each other, and the two feature extraction modules perform feature extraction on the sample image and the sample reference image, respectively.

The reference image feature includes a facial feature and a hairstyle feature. The hairstyle feature may be accurately determined by comparing the reference image feature extracted by the second feature extraction module with the facial feature extracted by the first feature extraction module. It should be noted that the first feature extraction module may further extract background features in the sample image, and the second feature extraction module may further extract background features in the sample reference image. Since the sample reference image and the sample image share the same background image and the accurate facial feature and the accurate hairstyle feature may be extracted through the two feature extraction modules without identifying segmentation boundaries between the face region, the hairstyle region and the background region in the present embodiment, the extraction of the background features is not specifically explained in the process of extracting the features.

At Step S3044, a reference portrait of the sample subject is generated based on the first facial feature and the first hairstyle feature.

During the generating of the reference portrait of the sample subject, dimensionality reduction may be performed on the first facial feature and the first hairstyle feature to obtain a second facial feature and a second hairstyle feature, that is, the latent features; and the reference portrait of the sample subject is generated based on the second facial feature and the second hairstyle feature.

In an embodiment, a generative adversarial network may be incorporated in the first neural network model to enable the first neural network model to learn an image generation capability of the generative adversarial network. During the reference portrait of the sample subject is generated by the generative adversarial network, dimensionality reduction is first performed on the first facial feature and the first hairstyle feature to obtain the latent features of the sample subject, the latent features including the second facial feature and the second hairstyle feature, the latent features of the sample subject are then input to the generative adversarial network, and the reference portrait of the sample subject is generated by the generative adversarial network based on the latent features.

The latent feature may be a one-dimensional feature. For example, features (including a face feature and a hairstyle feature) extracted by the feature extraction network are compressed into a 1×512 dimension feature, which is a latent feature. The generative adversarial network may have the advantage of generating detailed and realistic subject body images, such as portraits, based on a low dimension feature. In another embodiment, the features extracted by the feature extraction network may be directly input to the generative adversarial network to generate the portrait without dimensionality reduction. However, compared with directly inputting the extracted features to the generative adversarial network, performing dimensionality reduction before inputting the extracted features into the generative adversarial network significantly reduces the computational load of the generative adversarial network without noticeably affecting the quality of the portrait generated by the generative adversarial network.

The generative adversarial network may be a StyleGAN (Style-Based Generative Adversarial Network) generator, the StyleGAN generator is configured to generate new images that simulate real images, and has the powerful image generation capability. The StyleGAN generator may generate a detailed and realistic portrait based on the determined facial feature and the determined hairstyle feature.

In an embodiment, the first neural network model further includes a discriminator configured to constrain the generative adversarial network. The discriminator is used to authenticate the authenticity of a predicted portrait. The authenticity of the predicted portrait is understood as the authenticity of the image information contained in the predicted portrait. Since the predicted portrait is generated according to portrait features, which is obtained based on reference features in the reference portrait generated by the generative adversarial network, the authenticity of the predicted portrait may reflect the quality of the reference portrait generated by generative adversarial network. The discrimination result of the discriminator for the predicted portrait serves as the basis for training the portrait generation model. For example, in response to that the discrimination result is “false”, iterative training of the portrait generation model continues; in response to that the authentication result is “real”, the next iteration of training for the portrait generation model is stopped. With the iterative training of the model, the ability of the generative adversarial network to generate portraits becomes better and better, thereby allowing the portrait generation model to learn the stronger portrait generation capability.

At Step S3046, a sample portrait feature of the sample subject is determined based on the reference portrait, the first facial feature, and the first hairstyle feature, and a predicted portrait of the sample subject is generated based on the sample portrait feature.

Alternatively, during the determining of the sample portrait feature of the sample subject based on the reference portrait, the first facial feature, and the first hairstyle feature, feature extraction may first be performed on the reference portrait to obtain a first portrait feature corresponding to the reference portrait, then feature fusion is performed on the second facial feature, the second hairstyle feature, and the first facial feature to obtain a second portrait feature of the sample subject, and feature fusion is performed on the first portrait feature and the second portrait feature to obtain the sample portrait feature.

The latent features (including the second facial feature and the second hairstyle feature) are obtained by performing dimensionality reduction processing on the first facial feature and the first hairstyle feature. The second portrait feature, obtained by fusing the latent feature with the first facial feature extracted by the first feature extraction module, may have both low-resolution information from down-sampling and high-resolution information from up-sampling, thereby making the finally obtained portrait feature more comprehensive and more complete.

At Step S306, model parameters of the first neural network model are adjusted based on the sample image, the predicted portrait, the sample portrait, and the reference portrait to obtain a second neural network model.

In this step, a model loss value of the first neural network model is determined based on the sample image, the predicted portrait, the sample portrait, and the reference portrait, and the first neural network model is trained based on the model loss value. The second neural network model is a trained portrait generation model. The method for computing the model loss value will be described in detail in the following embodiments.

In an embodiment of the present application, a sample data set of a sample subject is obtained, where the sample data set includes a sample image, a sample reference image, and a sample portrait, and the sample reference image includes a background region image, a face region image, and a hairstyle region image; the sample data set is input into a first neural network model; and feature extraction is performed on the sample image and the sample reference image to obtain a facial feature and a hairstyle feature of the sample subject. It can be seen that during model training, the used sample data includes not only the sample reference image (i.e., a complete portrait), but also the sample image with the hairstyle region image removed (i.e., including only the background region image and a face region image). Therefore, accurate and rich hairstyle features, i.e., a hairstyle semantic structure may be extracted in the model training, rather than in simple hairstyle contour recognition. This provides strong semantic structural support for the model training. Further, a reference portrait of the sample subject is generated based on the facial feature and the hairstyle feature; a portrait feature of the sample subject is determined based on the reference portrait, the facial feature, and the hairstyle feature; a predicted portrait of the sample subject is generated based on the portrait feature; and model parameters of the first neural network model are adjusted based on the sample image, the predicted portrait, the sample portrait, and the reference portrait to obtain a second neural network model. Since the sample reference image provides accurate and rich hairstyle features for the model training, and the sample image provides accurate and rich facial features for the model training, iterative training of the model enables the generated predicted portrait to have a clear and natural hairstyle semantic structure and a clear and natural face semantic structure, and further enables the trained second neural network model to have the capability to generate a clear and natural portrait.

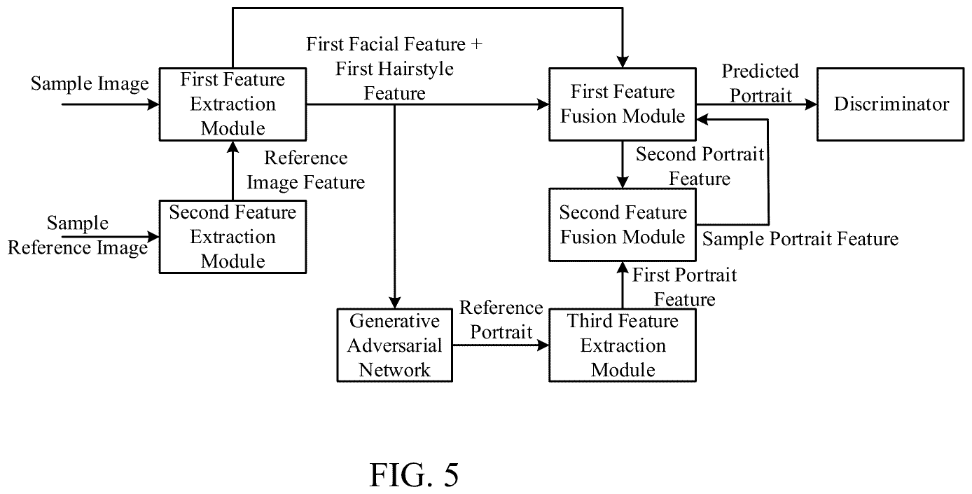

FIG. 5 is a schematic diagram of a method of training a portrait generation model according to some embodiments of the present application. As shown in FIG. 5, the portrait generation model to be trained includes a first feature extraction module, a second feature extraction module, a third feature extraction module, a first feature fusion module, a second feature fusion module, a generative adversarial network, and a discriminator configured to constrain the generative adversarial network. During the training of the portrait generation model, a sample data set of a sample subject is obtained. The sample data set includes a sample image, a sample reference image, and a sample portrait. The sample portrait is used as label information of the sample image. The sample image is input to the first feature extraction module while the sample reference image is input to the second feature extraction module. The first feature extraction module performs feature extraction on the sample image to obtain a first facial feature of the sample subject. The second feature extraction module performs feature extraction on the sample reference image to obtain a reference image feature of the sample subject. The second feature extraction module inputs the reference image feature to the first feature extraction module, and the first feature extraction module determines the first hairstyle feature based on the reference image feature and the first facial feature.

Thereafter, the first feature extraction module inputs the first facial feature and the first hairstyle feature into the first feature fusion module, and simultaneously inputs the first facial feature and the first hairstyle feature to the generative adversarial network. The first feature fusion module fuses the first facial feature and the first hairstyle feature input by the first feature extraction module. The generative adversarial network generates a reference portrait based on the first facial feature and the first hairstyle feature input by the first feature extraction module. The reference portrait is input to the third feature extraction module, and the third feature extraction module performs feature extraction on the reference portrait to obtain a corresponding first portrait feature of the reference portrait. The first portrait feature is input to the second feature fusion module, while the first feature fusion module outputs the second portrait feature (i.e., a feature obtained by fusing the first facial feature with the first hairstyle feature) to the second feature fusion module, and the second feature fusion module further performs fusion processing on the first portrait feature and the second portrait feature to obtain the sample portrait feature of the sample subject.

Thereafter, the sample portrait feature is input to the first feature fusion module, and the first feature fusion module generates a predicted portrait based on the sample portrait feature. The predicted portrait is input to the discriminator, and the discriminator discriminates the authenticity of the image information in the predicted portrait based on the predicted portrait and the sample portrait and outputs a discrimination result. The discrimination result is either “real” or “fake”, commonly represented by numerical values “1” or “0”, respectively. That is, the discrimination result for the predicted portrait being “1” represents that the authenticity of the image information in the predicted portrait is higher, while the discrimination result for the predicted portrait being “0” represents that the authenticity of the image information in the predicted portrait is lower.

After the discriminator outputs the discrimination result for the predicted portrait, the model loss value of the first neural network model (i.e., the portrait generation model to be trained) is determined based on the sample image, the predicted portrait, the sample portrait, and the reference portrait, and the model parameters of the first neural network model are adjusted based on the model loss value.

The following describes in detail how to determine the model loss value of the first neural network model.

In an embodiment, the model loss value of the first neural network model is determined based on the sample image, the predicted portrait, the sample portrait, and the reference portrait, and the model parameters of the first neural network model are adjusted based on the model loss value. The method for determining the model loss value includes the following Steps A1 to A3.

At Step A1, a first loss value, a second loss value, and a third loss value of the first neural network model are determined based on the predicted portrait and the sample portrait. The first loss value represents a first difference between the predicted portrait and the sample portrait. The second loss value represents an image authenticity of the predicted portrait with respect to the sample portrait. The third loss value represents a second difference between the facial feature in the predicted portrait and the facial feature in the sample portrait.

The first loss value may be computed by using a mean squared error between the predicted portrait and the sample portrait to represent the difference. That is, the method of computing the first loss value Loss1 may be expressed as:

$$Loss 1 = mse ( net ( x ) , label ) ,$$

where x represents the sample image, net(x) represents the predicted portrait output by the first neural network model, Label represents label information, i.e. the sample portrait in the sample data set, and mse represents computing of the mean squared error between net(x) and Label.

During computing of the second loss value, the degree of the authenticity of the image information in the predicted portrait may be determined based on the degree of the authenticity of the image information in the sample portrait, and the second loss value may be determined based on the degree of the authenticity of the image information in the predicted portrait. Alternatively, the second loss value is determined by the discriminator. The predicted portrait and the sample portrait are input to the discriminator, the discriminator assesses the authenticity of the image information in the predicted portrait with respect to the authenticity of the image information in the sample portrait, and the second loss value is determined based on the discrimination result for the authenticity of the image information in the predicted portrait. “1” and “0” are used to represent the authenticity of the image information. That is, in response to that the discriminator outputs “1”, it represents that the discrimination result of the predicted portrait is real, and the accuracy of the image information contained in the predicted portrait is higher; and in response to that the discriminator output is “0”, it represents that the discrimination result of the predicted portrait is false, and the accuracy of the image information contained in the predicted portrait is lower. Since the sample portrait is label information used to train the first neural network model, the authenticity of the image information in the sample portrait may be considered to be 1, or a value close to 1. Under the condition that the sample portrait is input to the discriminator, the discriminator outputs a value of 1 or a value close to 1. The method of computing the second loss value Loss2 may be expressed as:

$$Loss 2 = {L}_{D} + {L}_{G}$$

$${L}_{D} = 1 / 2 {log ( D ( {I}_{g} ) - 1 )}^{2} + 1 / 2 {log ( D ( {I}_{0} ) - 0 )}^{2}$$

$${L}_{G} = log {( D ( {I}_{0} ) - 1 )}^{2} ,$$

where I₀ represents the sample portrait, I_{g} represents the predicted portrait output by the first neural network model, D(I₀) represents the output of the discriminator in response to inputting the sample portrait to the discriminator, and D(I_{g}) represents the output of the discriminator after the predicted portrait is input to the discriminator.

When computing the third loss value, face recognition can be performed on the predicted portrait and the sample portrait to obtain a third facial feature in the predicted portrait and a fourth facial feature in the sample portrait, and the third loss value may be determined according to the difference between the third facial feature and the fourth facial feature. Alternatively, the predicted portrait and the sample portrait are input to a pre-trained face recognition model, the predicted portrait and the sample portrait are respectively subjected to face recognition by the pre-trained face recognition model to obtain a third facial feature in the predicted portrait and a fourth facial feature in the sample portrait, and the third loss function value is determined based on a second difference between the third facial feature and the fourth facial feature. The pre-trained face recognition model may be any existing face recognition model, and the face recognition model has the capacity of recognizing a facial feature from an image including a face.

The third loss value Loss3 may be computed as:

$$Loss 3 = {‖ ∅ ( {I}_{g} ) - ∅ ( {I}_{0} ) ‖}_{2}^{2} ,$$

where I₀ represents the sample portrait, I_{g} represents the predicted portrait output by the first mode, Ø(I₀) represents the output of the face recognition model in response to inputting the sample portrait into the face recognition model, i.e., the fourth facial feature in the sample portrait, Ø(I_{g}) represents the output of the face recognition model in response to inputting the predicted portrait into the face recognition model, i.e., the third facial feature in the predicted portrait.

At Step A2, a fourth loss value of the first neural network model is determined based on the sample image and the reference portrait. The fourth loss value represents the third difference between the facial feature in the sample image and the facial feature in the reference portrait.

During computing of the fourth loss value, the sample image and the reference portrait may be input into a pre-trained identity recognition model, face recognition is performed on the sample image and the reference portrait by the pre-trained identity recognition model, respectively, to obtain a fifth facial feature in the sample image and a sixth facial feature in the reference portrait, and the fourth loss value is determined based on the third difference between the fifth facial feature and the sixth facial feature.

The method of computing the fourth loss value Loss4 may be expressed as:

$$Loss 4 = 1 - cos ( arcface ( x ) , arcface ( face ) ) ,$$

where x represents the sample image, face represents the reference portrait generated by the generative adversarial network, Arcface(x) represents the output of the identity recognition model for the sample image being input to the identity recognition model, i.e., the fifth facial feature in the sample image, and Arcface(face) represents the output of the identity recognition model for the reference portrait being input into the identity recognition model, i.e., the sixth facial feature in the reference portrait.

It should be noted that, although a facial feature is also extracted during the computing of the fourth loss value, the facial feature involved in the fourth loss value is more focused on an ID feature that uniquely represents the user's identity, such as an iris feature, a skin feature, and the like extractable from a person's face.

The fourth loss value may represent the difference between the facial feature in the sample image and the facial feature in the reference portrait. Further, the fourth loss value may represent the difference between the ID feature of the sample image and the ID feature of the reference portrait. Therefore, the reference portrait generated by the generative adversarial network is constrained based on the fourth loss value, so that the generative adversarial network may finally generate the reference portrait of the same ID features as the sample image as the number of iterations increases, thereby enabling the generated predicted portrait to also maintain the same ID features as the sample image. Based on this, as the number of iterations increases, the first neural network model may gradually learn the capability to generate portraits of the same ID features from the generative adversarial network, ensuring that the portraits generated by the trained second neural network model are more realistic.

At Step A3, a model loss value of the first neural network model is determined based on the first loss value, the second loss value, the third loss value, and the fourth loss value, and model parameters of the first neural network model are adjusted based on the model loss value.

The method of computing the model loss value Loss may be expressed as:

$$Loss = a Loss 1 + b Loss 2 + c Loss 3 + d Loss 4 ,$$

where a, b, c, and d are weights of the first loss value, the second loss value, the third loss value, and the fourth loss value, respectively. The values of the weights of the first loss value, the second loss value, the third loss value, and the fourth loss value may be set according to the specific requirements. For example, Loss=5Loss1+2Loss2+5Loss3+2Loss4.

It can be seen that the model loss value computed in the present embodiment may simultaneously represent the following information: the difference between the predicted portrait and the sample portrait, the authenticity of the image information in the predicted portrait, the difference between the facial feature in the predicted portrait and the facial feature in the sample portrait, and the difference between the facial feature in the sample image and the facial feature in the reference portrait. Therefore, as the number of iterations increases, the difference between the predicted portrait and the sample portrait becomes less and less, the authenticity of the image information in the predicted portrait becomes higher and higher, the difference between the facial feature in the predicted portrait and the facial feature in the sample portrait becomes less and less, and the difference between the facial feature in the sample image and the facial feature in the reference portrait becomes less and less. Thus, a detailed and realistic portrait is generated based on the generated manner, and the generated portrait has the same ID features as the sample image and the sample reference image.

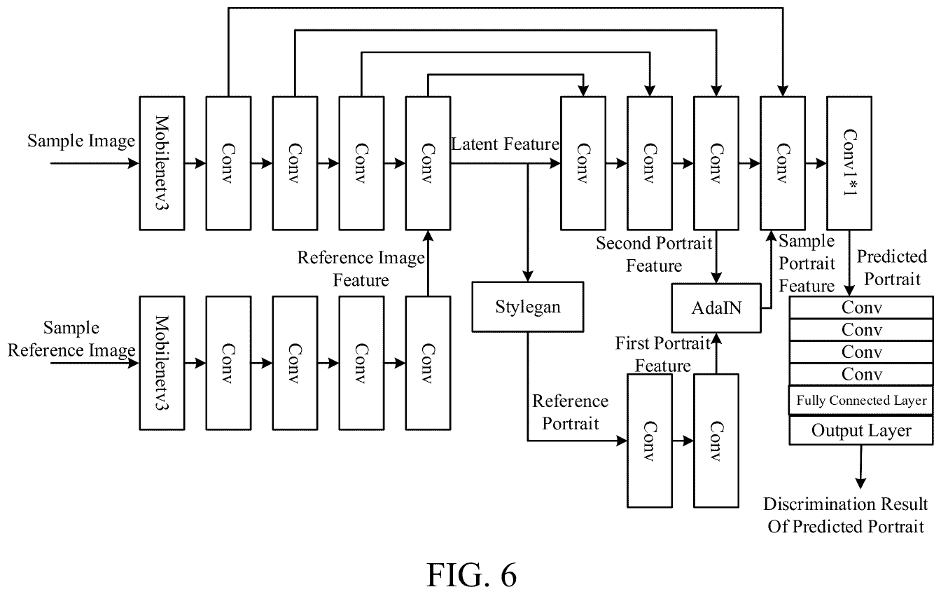

FIG. 6 is a schematic diagram of a method of training a portrait generation model according to another embodiment of the present application. In the present embodiment, the structure of each module in the portrait generation model is divided in more detail. The portrait generation model to be trained includes a first feature extraction module, a second feature extraction module, a third feature extraction module, a first feature fusion module, a second feature fusion module, a generative adversarial network, and a discriminator configured to constrain the generative adversarial network.

As shown in FIG. 6, the first feature extraction module includes a feature extraction layer (e.g., pre-trained MobileNetV3) and four convolutional layers conv. Each of the four convolution layers conv, as the down-sampling layer, uses a 3×3 convolution with a stride of 2 and a kernel size of 64. Each of the four convolution layers is followed by an activation layer (not shown) for activating the extracted feature. Each of the four convolutional layers conv generates a first facial feature and a background feature by down-sampling the sample image.

The second feature extraction module also includes a feature extraction layer (e.g., pre-trained MobileNetV3) and four convolutional layers conv. The structure of the second feature extraction module is similar to that of the first feature extraction module, except that the input data input to the second feature extraction module is different from that of the first feature extraction module. Each of the convolutional layers conv in the second feature extraction module generates a reference image feature by down-sampling the sample reference image. The reference image feature includes the first facial feature, the first hairstyle feature, and the background feature. The last convolution layer conv in the second feature extraction module outputs the reference image feature generated by the last convolution layer conv to the last convolution layer conv in the first feature extraction module, and the last convolution layer conv in the first feature extraction module fuses (e.g., serially fuses) the output of its previous convolution layer conv (including the first facial feature and the background feature) in the first feature extraction module with the reference image feature. The fused feature is dimensionality-reduced to one-dimensional feature, i.e., the latent features including the second facial feature and the second hairstyle feature. The latent features are input to the first feature fusion module and the generative adversarial network. It can be seen that the inputting of the sample reference image is to provide the hairstyle feature so that the feature extraction network may extract accurate hairstyle features, rather than identifying the hairstyle region by the contour recognition.

The generative adversarial network may be a StyleGAN generator, the StyleGAN generator is configured to generate new images that simulate real images, and has the powerful image generation capability. The StyleGAN generator generates a reference portrait based on the latent features including the second facial feature and the second hairstyle feature, and outputs the reference portrait to the third feature extraction module. The third feature extraction module includes two convolutional layers conv for performing feature extraction on the reference portrait to obtain the first portrait feature corresponding to the reference portrait, and the first portrait feature is input to the second feature fusion module. Each of the two convolution layers conv in the third feature extraction module is 3×3×64 convolutions.

The first feature fusion module includes four convolutional layers conv and one convolutional output layer conv1*1. The four convolutional layers conv as up-sampling layers, each uses a 3×3 convolution with a stride of 2 and a kernel size of 64. Each of the four convolution layers is followed by an activation layer (not shown) for activating the features obtained by up-sampling. Each of the four convolutional layers conv may generate a finer feature (including the facial feature and the hairstyle feature) that is up-sampled by a factor of 2. The third convolutional layer conv in the first feature fusion module outputs the features obtained by up-sampling to the second feature fusion module. The features up-sampled by the third convolution layer conv include a feature up-sampled by its previous convolution layer conv and a feature down-sampled by the second convolution layer conv in the first feature extraction module. The second feature obtained by fusing the above information is input to the second feature fusion module.

The second feature fusion module may include an AdaIN (Adaptive Instance Normalization) layer configured to perform fusion processing on the first portrait feature output from the third feature extraction module and the second portrait feature output from the first feature fusion module by using the fusion function of the AdaIN layer to obtain the sample portrait feature of the sample subject, and then the sample portrait feature is input to the last convolution layer conv in the first feature fusion module. The fourth convolution layer conv in the second feature fusion module may fuse the sample portrait feature with the feature down-sampled by the first convolution layer conv in the first feature extraction module, and output the fused feature to the convolution output layer conv1*1 to output the predicted portrait from the convolution output layer conv1*1. The convolution output layer conv1*1 is a 1×1×3 convolution, and the predicted portrait is input to the discriminator from the convolution output layer conv1*1.

The discriminator includes four convolutional layers conv, one full connected layer, and one output layer. The channel configuration of the discriminator is (64, 1). The discriminator outputs a discrimination result regarding the authenticity of the image information in the predicted portrait. The numbers “1” or “0” may represent the predicted portrait is real or fake. The discrimination result regarding the authenticity of the image information in the predicted portrait by the discriminator is used to constrain the generative adversarial network, which forms an adversarial training with the generative adversarial network.

In this embodiment, the method of computing the model loss value of the portrait generation model to be trained is the method of computing the model loss value of the first neural network model, which has been described in detail in the above-mentioned embodiment, and will not be repeated here.

In the method of training the portrait generation model according to an embodiment of the present application, during the training of the portrait generation model, the used sample data includes not only the sample reference image (i.e., a complete portrait), but also the sample image (i.e., an image with the hairstyle region image removed). Therefore, accurate and rich hairstyle features, i.e., a hairstyle semantic structure may be extracted in the model training, rather than in simple hairstyle contour recognition. This provides strong semantic structural support for the model training. Further, since the sample reference image provides accurate and rich hairstyle features for the model training, and the sample image provides accurate and rich facial features for the model training, iterative training of the model enables the generated predicted portrait to have a clear and natural hairstyle semantic structure and a clear and natural face semantic structure, and further enables the trained second neural network model to have the capability to generate a clear and natural portrait. In addition, by determining the model loss value of the portrait generation model to be trained based on the sample image, the predicted portrait, the sample portrait and the reference portrait, the model training process is subjected to the following constraints: the difference between the predicted portrait generated by the model generation model and the sample portrait, the authenticity of the image information in the predicted portrait, the difference between the facial feature in the predicted portrait and the facial feature in the sample portrait, and the difference between the facial feature in the sample image and the facial feature in the reference portrait. Therefore, as the number of iterations increases, the difference between the predicted portrait and the sample portrait becomes less and less, the authenticity of the image information in the predicted portrait becomes higher and higher, the difference between the facial feature in the predicted portrait and the facial feature in the sample portrait becomes less and less, and the difference between the facial feature in the sample image and the facial feature in the reference portrait becomes less and less. Thus, a detailed and realistic portrait is generated based on the generated manner, and the generated portrait has the same ID features as the sample image and the sample reference image.

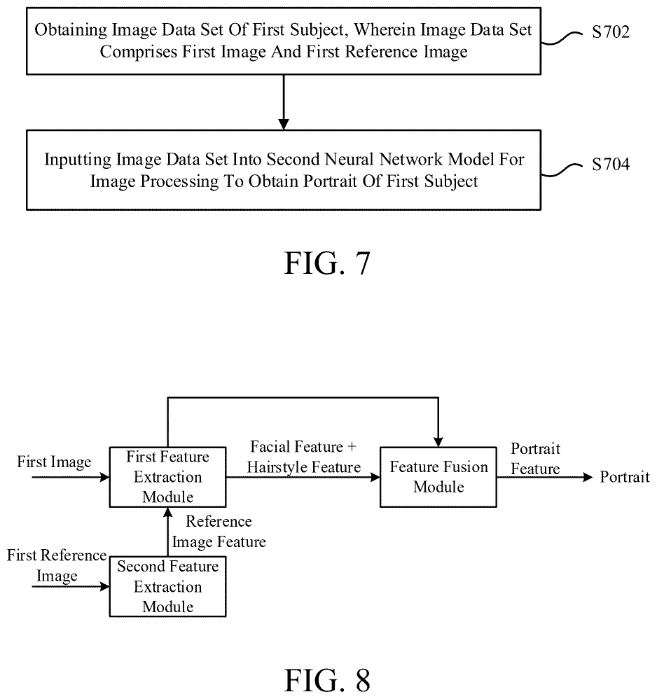

FIG. 7 is a schematic flowchart of a portrait generation method according to some embodiments of the present application. As shown in FIG. 7, the method includes Step S702 to Step S704.

At Step S702, an image data set of a first subject is obtained, the image data set including the first image and the first reference image.

The first reference image includes a background region image, a face region image, and a hairstyle region image. The first image is obtained by removing the hairstyle region image from the first reference image. The first image includes a face region image and a background region image.

During the obtaining of the image data set of the first subject, the first reference image of the first subject may be obtained first, and then a mask processing is performed on the hairstyle region image in the first reference image to obtain the first image. Alternatively, the first image may be obtained by directly erasing the hairstyle region image from the first reference image.

At Step S704, the image data set is input into the second neural network model for image processing to obtain a portrait of the first subject.

The second neural network model is obtained by the method of training the first neural network model according to any of the above embodiments. In the portrait generation scene, the first neural network model is a portrait generation model to be trained, and the second neural network model is a trained portrait generation model.

In an embodiment, the second neural network model includes a first feature extraction module and a second feature extraction module. Based on this, when the image data set is input into the second neural network model for image processing, the image processing process may include Step B1 to Step B3.

At Step B1, feature extraction is performed on the first image and the first reference image to obtain a facial feature and a hairstyle feature of the first subject.

Alternatively, the feature extraction is performed on the first image by the first feature extraction module to obtain the facial feature of the first subject.

The feature extraction is performed on the first reference image by the second feature extraction module to obtain the hairstyle feature of the first subject.

At Step B2, a portrait feature of the first subject is determined based on the facial feature and the hairstyle feature.

At Step B3, a portrait of the first subject is generated based on the portrait feature.

FIG. 8 is a schematic diagram of a portrait generation method according to some embodiments of the present application. As shown in FIG. 8, the trained portrait generation model includes a first feature extraction module, a second feature extraction module, and a feature fusion module.

The image data set of the first subject is input to the trained portrait generation model. In an embodiment, the first image is input to the first feature extraction module and the first reference image is input to the second feature extraction module. The first feature extraction module performs feature extraction on the first image to obtain the facial feature of the first subject. The second feature extraction module performs feature extraction on the first reference image to obtain the reference image feature of the first subject. The reference image features is input to the first feature extraction module from the second feature extraction module, and the hairstyle feature is determined by the first feature extraction module based on the reference image features and the facial features.

Then, the facial feature and the hairstyle feature are input to the feature fusion module from the first feature extraction module. The feature fusion module fuses the facial feature with the hairstyle feature input from the first feature extraction module to obtain the portrait feature of the first subject. The portrait of the first subject is generated based on the portrait feature.

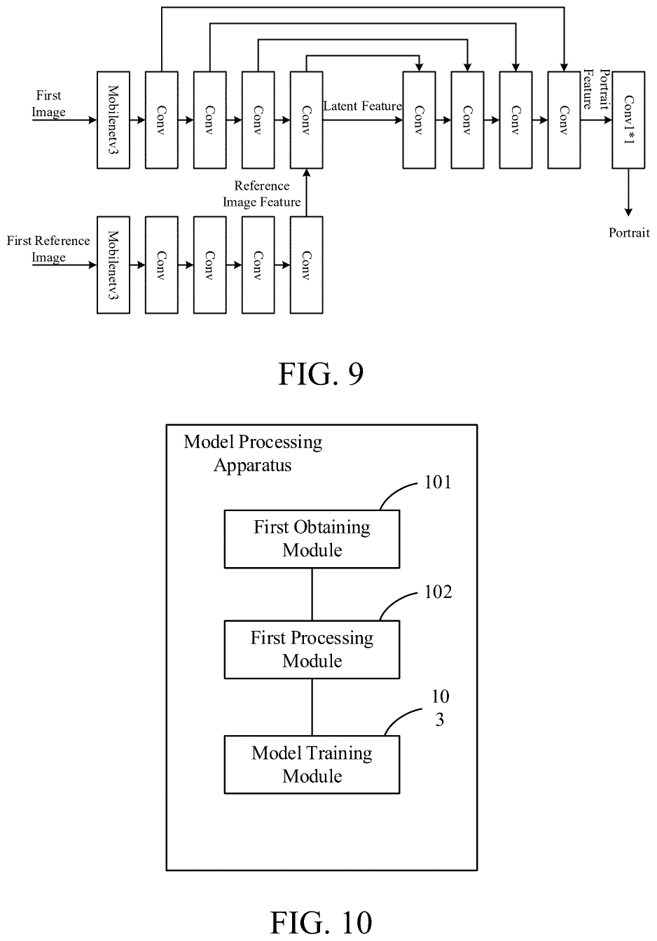

FIG. 9 is a schematic diagram of a portrait generation method according to another embodiment of the present application. As shown in FIG. 9, the first feature extraction module includes a feature extraction layer (such as a pre-trained MobileNetV3) and four convolutional layers conv. Each of the four convolution layers conv, as the down-sampling layer, uses a 3×3 convolution with a stride of 2 and a kernel size of 64. Each of the four convolution layers is followed by an activation layer (not shown) for activating the extracted feature. Each of the four convolutional layers conv generates the facial feature and the background feature by down-sampling the first image.

The second feature extraction module also includes a feature extraction layer (e.g., pre-trained MobileNetV3) and four convolutional layers conv. The structure of the second feature extraction module is similar to that of the first feature extraction module, except that the input data input to the second feature extraction module is different from that of the first feature extraction module. Each of the convolutional layers conv in the second feature extraction module generates a reference image feature by down-sampling the first reference image. The reference image feature includes the facial feature, the hairstyle feature, and the background feature. The last convolution layer conv in the second feature extraction module outputs the reference image feature generated by the last convolution layer conv to the last convolution layer conv in the first feature extraction module, and the last convolution layer conv in the first feature extraction module fuses (e.g., serially fuses) the output of its previous convolution layer conv (including the facial feature and the background feature) in the first feature extraction module with the reference image feature. The fused feature is dimensionality-reduced to one-dimensional feature, i.e., the latent features including dimensionality-reduced facial and hairstyle features. The latent features are input to the feature fusion module. It can be seen that the inputting of the first reference image is to provide the hairstyle feature to the portrait generation model so that the feature extraction network may extract the accurate hairstyle feature, rather than identifying the hairstyle region by the contour recognition.

The feature fusion module includes four convolutional layers conv and one convolutional output layer conv1*1. The four convolutional layers conv as up-sampling layers, each uses a 3×3 convolution with a stride of 2 and a kernel size of 64. Each of the four convolution layers is followed by an activation layer (not shown) for activating the features obtained by up-sampling. Each of the four convolutional layers conv may generate a finer feature (including the facial feature and the hairstyle feature) that is up-sampled by a factor of 2. The last convolutional layer conv generates the portrait feature of the first subject by fusing the features, and outputs the portrait feature to the convolutional output layer conv1*1. The portrait of the first subject is output by the convolutional output layer conv1*1.

In the above embodiment, an image data set of a first subject is obtained, the image data set is input into the trained second neural network model, and a portrait of the first subject is generated by the trained second neural network model based on a first image and a first reference image. Since accurate and rich facial features and accurate and rich hairstyle features may be extracted in training the second neural network model, the portrait generated by the trained second neural network model has a clear and natural hairstyle semantic structure and a clear and natural face semantic structure, and thus may realize the effect of generating a clear and natural portrait.

To sum up, some embodiments of the present application have been described above. Other embodiments fall within the scope of the appended claims. In some cases, the operations recited in the claims may be performed in an order different from that described in the embodiments and still achieve the desired results. Furthermore, the processes depicted in the accompanying drawings do not necessarily require the specific or the sequential order shown to achieve the desired results. In certain implementations, multitasking and parallel processing may be advantageous.

The above-described model processing method and portrait generation method are provided in the embodiments of the present application. Based on the same inventive concept, some embodiments of the present application further provide a model processing apparatus and a portrait generation apparatus.

FIG. 10 is a schematic block diagram of a model processing apparatus according to some embodiments of the present application. As shown in FIG. 10, the model processing apparatus includes a first obtaining module 101, a first processing module 102, and a model training module 103.

The first obtaining module 101 is configured to obtain a sample data set for a sample subject. The sample data set includes a sample image, a sample reference image, and a sample portrait, the sample reference image includes a background region image, a face region image, and a hairstyle region image, and the sample image is obtained by removing the hairstyle region image from the sample reference image.

The first processing module 102 is configured to input the sample data set into a first neural network model for image processing to obtain a predicted portrait of the sample subject. The image processing includes: performing feature extraction on the sample image and the sample reference image to obtain a first facial feature and a first hairstyle feature of the sample subject; generating a reference portrait of the sample subject based on the first facial feature and the first hairstyle feature; determining a sample portrait feature of the sample subject based on the reference portrait, the first facial feature, and the first hairstyle feature; and generating a predicted portrait based on the sample portrait feature.

The model training module 103 is configured to adjust model parameters of the first neural network model based on the sample image, the predicted portrait, the sample portrait, and the reference portrait to obtain a second neural network model.

In an embodiment, during the generating of the reference portrait of the sample subject based on the first facial feature and the first hairstyle feature, the first processing module 102 performs the steps of:
performing dimensionality reduction processing on the first facial feature and the first hairstyle feature to obtain a second facial feature and a second hairstyle feature of the sample subject; and
generating the reference portrait of the sample subject based on the second facial feature and the second hairstyle feature.

In an embodiment, during the determining of the sample portrait feature of the sample subject based on the reference portrait, the first processing module 102 performs the steps of:
performing feature extraction on the reference portrait to obtain a first portrait feature corresponding to the reference portrait;
performing feature fusion processing on the second facial feature, the second hairstyle feature, and the first facial feature to obtain the second portrait feature of the sample subject; and
performing feature fusion processing on the first portrait feature and the second portrait feature to obtain the sample portrait feature.

In an embodiment, during the adjusting of the model parameters of the first neural network model based on the sample image, the predicted portrait, the sample portrait, and the reference portrait, the model training module 103 performs the steps of:
determining a first loss value, a second loss value, and a third loss value of the first neural network model based on the predicted portrait and the sample portrait, where the first loss value represents a first difference between the predicted portrait and the sample portrait, the second loss value represents authenticity of image information of the predicted portrait, and the third loss value represents a second difference between a facial feature in the predicted portrait and a facial feature in the sample portrait;
determining a fourth loss value of the first neural network model based on the sample image and the reference portrait, where the fourth loss value represents a third difference between a facial feature in the sample image and the facial feature in the reference portrait; and
determining a model loss value of the first neural network model based on the first loss value, the second loss value, the third loss value, and the fourth loss value, and adjusting the model parameters based on the model loss value.

In an embodiment, the first neural network model includes a first feature extraction module and a second feature extraction module;

The first processing module 102 performs the following steps during the performing of the feature extraction on the sample image and the sample reference image to obtain the first facial feature and the first hairstyle feature of the sample subject:
performing feature extraction on the sample image by the first feature extraction module to obtain the first facial feature of the sample subject;
performing feature extraction on the sample reference image by the second feature extraction module to obtain a reference image feature of the sample subject; and
processing the first facial feature and the reference image feature by the first feature extraction module to obtain the first hairstyle feature.

In the model processing apparatus according to an embodiment of the present application, a sample data set of a sample subject is obtained, where the sample data set includes a sample image, a sample reference image, and a sample portrait, and the sample reference image includes a background region image, a face region image, and a hairstyle region image; the sample data set is input into a first neural network model; and feature extraction is performed on the sample image and the sample reference image to obtain a facial feature and a hairstyle feature of the sample subject. It can be seen that during model training, the used sample data includes not only the sample reference image (i.e., a complete portrait), but also the sample image with the hairstyle region image removed (i.e., including only the background region image and a face region image). Therefore, accurate and rich hairstyle features, i.e., a hairstyle semantic structure may be extracted in the model training, rather than in simple hairstyle contour recognition. This provides strong semantic structural support for the model training. Further, a reference portrait of the sample subject is generated based on the facial feature and the hairstyle feature; a portrait feature of the sample subject is determined based on the reference portrait, the facial feature, and the hairstyle feature; a predicted portrait of the sample subject is generated based on the portrait feature; and model parameters of the first neural network model are adjusted based on the sample image, the predicted portrait, the sample portrait, and the reference portrait to obtain a second neural network model. Since the sample reference image provides accurate and rich hairstyle features for the model training, and the sample image provides accurate and rich facial features for the model training, iterative training of the model enables the generated predicted portrait to have a clear and natural hairstyle semantic structure and a clear and natural face semantic structure, and further enables the trained second neural network model to have the capability to generate a clear and natural portrait.

It will be appreciated by those skilled in the art that the model processing apparatus of FIG. 10 may be used to implement the model processing method described above, the detailed description of which should be similar to that in the previous model processing method, and to avoid redundancy, details will not be described herein.

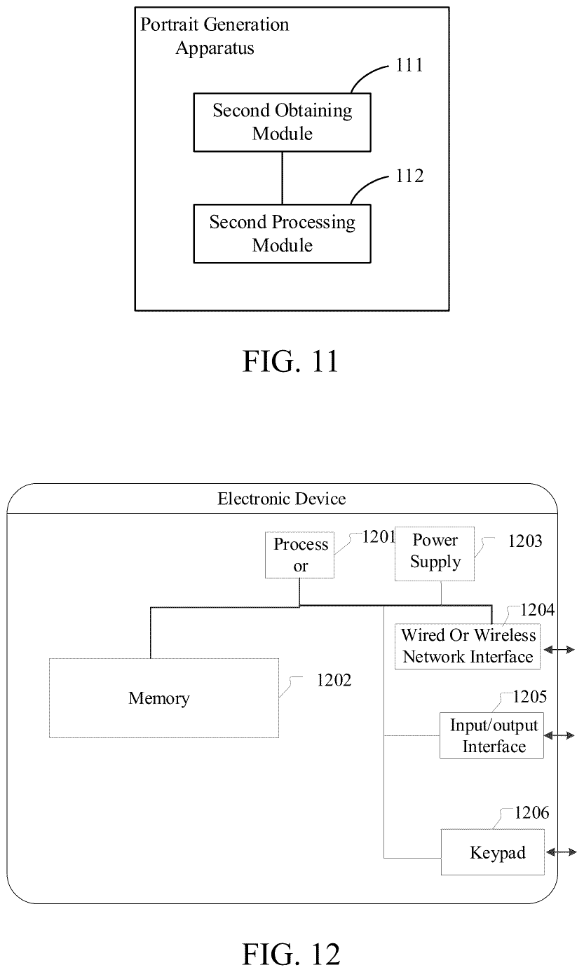

FIG. 11 is a schematic block diagram of a portrait generation apparatus according to some embodiments of the present application. As shown in FIG. 11, the portrait generation apparatus includes a second obtaining module 111 and a second processing module 112.

The second obtaining module 111 is configured to obtain an image data set of a first subject, where the image data set includes a first image and a first reference image, the first reference image includes a background region image, a face region image, and a hairstyle region image, and the first image is obtained by removing the hairstyle region image from the first reference image.

The second processing module 112 is configured to input the image data set into a second neural network model for image processing to obtain a portrait of the first subject, where the image processing includes: performing feature extraction on the first image and the first reference image to obtain a facial feature and a hairstyle feature of the first subject; determining a portrait feature of the first subject based on the facial feature and the hairstyle feature; and generating a portrait of the first subject based on the portrait feature.

In an embodiment, the second neural network model includes a first feature extraction module and a second feature extraction module;

During the performing of the feature extraction on the first image and the first reference image to obtain the facial feature and the hairstyle feature of the first subject and the determining of the portrait feature of the first subject based on the facial feature and the hairstyle feature, the second processing module 112 performs the following steps:
performing feature extraction on the first image by the first feature extraction module to obtain the facial feature of the first subject;
performing feature extraction on the first reference image by the second feature extraction module to obtain the hairstyle feature of the first subject; and
fusing the facial feature with the hairstyle feature to obtain the portrait feature of the first subject.

In the portrait generation apparatus according to the above embodiment, an image data set of a first subject is obtained, the image data set is input into the trained second neural network model, and a portrait of the first subject is generated by the trained second neural network model based on a first image and a first reference image. Since accurate and rich facial features and accurate and rich hairstyle features may be extracted in training the second neural network model, the portrait generated by the trained second neural network model has a clear and natural hairstyle semantic structure and a clear and natural face semantic structure, and thus may realize the effect of generating a clear and natural portrait.

It will be appreciated by those skilled in the art that the portrait generation apparatus of FIG. 11 may be used to implement the portrait generation method described above, the detailed description of which should be similar to that in the previous portrait generation method, and to avoid redundancy, details will not be described herein.

Based on the same inventive concept, an embodiment of the present application also provides an electronic device, as shown in FIG. 12. The electronic device may vary considerably by having different configurations or performances, and may include one or more processors 1201 and one or more memories 1202 in which one or more stored application programs or data may be stored. The memory 1202 may be temporary storage or persistent storage. The application program stored in the memory 1202 may include one or more modules (not shown), each of the modules may include a series of computer-executable instructions for the electronic device. Further, the processor 1201 may be configured to communicate with the memory 1202 to execute a series of computer-executable instructions in the memory 1202 on an electronic device. The electronic device may further include one or more power supplies 1203, one or more wired or wireless network interfaces 1204, one or more input/output interfaces 1205, one or more keypads 1206.

In an embodiment, the electronic device includes a memory and one or more programs. The one or more programs are stored in the memory, the one or more programs may include one or more modules, and each module may include a series of computer-executable instructions for the electronic device, and configured to execute the one or more programs including the following computer-executable instructions by the one or more processors:
obtaining a sample data set for a sample subject, where the sample data set includes a sample image, a sample reference image, and a sample portrait, the sample reference image includes a background region image, a face region image, and a hairstyle region image, and the sample image is obtained by removing the hairstyle region image from the sample reference image;
inputting the sample dataset into data set into a first neural network model for image processing to obtain a predicted portrait of the sample subject, where the image processing includes: performing feature extraction on the sample image and the sample reference image to obtain a first facial feature and a first hairstyle feature of the sample subject; generating a reference portrait of the sample subject based on the first facial feature and the first hairstyle feature; determining a sample portrait feature of the sample subject based on the reference portrait, the first facial feature, and the first hairstyle feature; and generating a predicted portrait based on the sample portrait feature; and
adjusting model parameters of the first neural network model based on the sample image, the predicted portrait, the sample portrait, and the reference portrait to obtain a second neural network model.

In an embodiment of the present application, a sample data set of a sample subject is obtained, where the sample data set includes a sample image, a sample reference image, and a sample portrait, and the sample reference image includes a background region image, a face region image, and a hairstyle region image; the sample data set is input into a first neural network model; and feature extraction is performed on the sample image and the sample reference image to obtain a facial feature and a hairstyle feature of the sample subject. It can be seen that during model training, the used sample data includes not only the sample reference image (i.e., a complete portrait), but also the sample image with the hairstyle region image removed (i.e., including only the background region image and a face region image). Therefore, accurate and rich hairstyle features, i.e., a hairstyle semantic structure may be extracted in the model training, rather than in simple hairstyle contour recognition. This provides strong semantic structural support for the model training. Further, a reference portrait of the sample subject is generated based on the facial feature and the hairstyle feature; a portrait feature of the sample subject is determined based on the reference portrait, the facial feature, and the hairstyle feature; a predicted portrait of the sample subject is generated based on the portrait feature; and model parameters of the first neural network model are adjusted based on the sample image, the predicted portrait, the sample portrait, and the reference portrait to obtain a second neural network model. Since the sample reference image provides accurate and rich hairstyle features for the model training, and the sample image provides accurate and rich facial features for the model training, iterative training of the model enables the generated predicted portrait to have a clear and natural hairstyle semantic structure and a clear and natural face semantic structure, and further enables the trained second neural network model to have the capability to generate a clear and natural portrait.

In another embodiment, the electronic device includes a memory and one or more programs. The one or more programs are stored in the memory, the one or more programs may include one or more modules, and each module may include a series of computer-executable instructions for the electronic device, and configured to execute the one or more programs including the following computer-executable instructions by the one or more processors:
obtaining an image data set of a first subject, where the image data set includes a first image and a first reference image, the first reference image includes a background region image, a face region image, and a hairstyle region image, and the first image is obtained by removing the hairstyle region image from the first reference image; and
inputting the image data set into a second neural network model for image processing to obtain a portrait of the first subject, where the image processing includes: performing feature extraction on the first image and the first reference image to obtain a facial feature and a hairstyle feature of the first subject; determining a portrait feature of the first subject based on the facial feature and the hairstyle feature; and generating a portrait of the first subject based on the portrait feature.

In the above embodiment, an image data set of a first subject is obtained, the image data set is input into the trained second neural network model, and a portrait of the first subject is generated by the trained second neural network model based on a first image and a first reference image. Since accurate and rich facial features and accurate and rich hairstyle features may be extracted in training the second neural network model, the portrait generated by the trained second neural network model has a clear and natural hairstyle semantic structure and a clear and natural face semantic structure, and thus may realize the effect of generating a clear and natural portrait.

An embodiment of the present application further provides a computer-readable storage medium storing one or more computer programs, and the one or more computer programs include instructions that, when executed by an electronic device including a plurality of application programs, enable the electronic device to perform various operations of the model processing method according to the above-described embodiments:
obtaining a sample data set for a sample subject, where the sample data set includes a sample image, a sample reference image, and a sample portrait, the sample reference image includes a background region image, a face region image, and a hairstyle region image, and the sample image is obtained by removing the hairstyle region image from the sample reference image;
inputting the sample data set into a first neural network model for image processing to obtain a predicted portrait of the sample subject, where the image processing includes: performing feature extraction on the sample image and the sample reference image to obtain a first facial feature and a first hairstyle feature of the sample subject; generating a reference portrait of the sample subject based on the first facial feature and the first hairstyle feature; determining a sample portrait feature of the sample subject based on the reference portrait, the first facial feature, and the first hairstyle feature; and generating a predicted portrait based on the sample portrait feature; and
adjusting model parameters of the first neural network model based on the sample image, the predicted portrait, the sample portrait, and the reference portrait to obtain a second neural network model.

In an embodiment of the present application, a sample data set of a sample subject is obtained, where the sample data set includes a sample image, a sample reference image, and a sample portrait, and the sample reference image includes a background region image, a face region image, and a hairstyle region image; the sample data set is input into a first neural network model; and feature extraction is performed on the sample image and the sample reference image to obtain a facial feature and a hairstyle feature of the sample subject. It can be seen that during model training, the used sample data includes not only the sample reference image (i.e., a complete portrait), but also the sample image with the hairstyle region image removed (i.e., including only the background region image and a face region image). Therefore, accurate and rich hairstyle features, i.e., a hairstyle semantic structure may be extracted in the model training, rather than in simple hairstyle contour recognition. This provides strong semantic structural support for the model training. Further, a reference portrait of the sample subject is generated based on the facial feature and the hairstyle feature; a portrait feature of the sample subject is determined based on the reference portrait, the facial feature, and the hairstyle feature; a predicted portrait of the sample subject is generated based on the portrait feature; and model parameters of the first neural network model are adjusted based on the sample image, the predicted portrait, the sample portrait, and the reference portrait to obtain a second neural network model. Since the sample reference image provides accurate and rich hairstyle features for the model training, and the sample image provides accurate and rich facial features for the model training, iterative training of the model enables the generated predicted portrait to have a clear and natural hairstyle semantic structure and a clear and natural face semantic structure, and further enables the trained second neural network model to have the capability to generate a clear and natural portrait.

An embodiment of the present application further provides a computer-readable storage medium storing one or more computer programs, and the one or more computer programs include instructions that, when executed by an electronic device including a plurality of application programs, enable the electronic device to perform various operations of the portrait generation method according to the above-described embodiments:
obtaining an image data set of a first subject, where the image data set includes a first image and a first reference image, the first reference image includes a background region image, a face region image, and a hairstyle region image, and the first image is obtained by removing the hairstyle region image from the first reference image; and
inputting the image data set into a second neural network model for image processing to obtain a portrait of the first subject, where the image processing includes: performing feature extraction on the first image and the first reference image to obtain a facial feature and a hairstyle feature of the first subject; determining a portrait feature of the first subject based on the facial feature and the hairstyle feature; and generating a portrait of the first subject based on the portrait feature.

In the above embodiment, an image data set of a first subject is obtained, the image data set is input into the trained second neural network model, and a portrait of the first subject is generated by the trained second neural network model based on a first image and a first reference image. Since accurate and rich facial features and accurate and rich hairstyle features may be extracted in training the second neural network model, the portrait generated by the trained second neural network model has a clear and natural hairstyle semantic structure and a clear and natural face semantic structure, and thus may realize the effect of generating a clear and natural portrait.

An embodiment of the present application provides a computer program product including a computer program executable by a processor to perform each of operations of a model processing method according to any of the above-described embodiments, or the computer program executable by a processor to perform each of operations of a portrait generation method according to any of the above-described embodiments, and the same technical effect may be achieved. To avoid redundancy, details are not described herein.

The system, apparatus, module or unit set forth in the above embodiments may be embodied by a computer chip or entity or by a product having a certain function. An example implementation device is a computer. For example, the computer may be, for example, a personal computer, a laptop computer, a cellular phone, a camera phone, a smart phone, a personal digital assistant, a media player, a navigation device, an email device, a game console, a tablet computer, a wearable device, or a combination of any of these devices.

For convenience of description, the above apparatus is described separately in terms of various function units divided according to its functions. The functions of the function units may be implemented in the same software and/or hardware when implementing the present application.

Those skilled in the art will appreciate that embodiments of the present application may be provided as a method, system, or computer program product. Thus, the present application may take the form of a full hardware embodiment, a full software embodiment, or an embodiment incorporating both software and hardware aspects. Furthermore, the present application may take the form of a computer program product embodied on one or more computer usable storage media (including, but not limited to, magnetic disk memory, CD-ROM, optical memory, etc.) having computer usable program code embodied therein.

The present application is described with reference to flowcharts and/or block diagrams of methods, devices (systems), and computer program products according to embodiments of the present application. It is to be understood that each operation and/or block in the flowcharts and/or block diagrams, and combinations of the operations and/or blocks in the flowcharts and/or block diagrams may be implemented by computer program instructions. These computer program instructions may be provided to a processor of a general purpose computer, a special purpose computer, an embedded processor, or other programmable data processing device to generate a machine such that the instructions executable by the processor of the computer or other programmable data processing device generate means for performing operations specified in one or more flows in the flowchart and/or one or more blocks in the block diagram.

These computer program instructions may further be stored in a computer-readable memory configured to direct a computer or other programmable data processing apparatus to operate in a particular manner, such that the instructions stored in the computer-readable memory generate an manufacture product including instruction means that perform operations specified in one or more flows in the flowchart and/or one or more blocks in the block diagram.

These computer program instructions may further be loaded onto a computer or other programmable data processing device such that a series of operational steps are performed on the computer or the other programmable device to generate a computer-implemented process, such that the instructions that execute on the computer or the other programmable device provide steps for performing operations specified in one or more flows in the flowchart and/or one or more blocks in the block diagram.

In an example configuration, the computing device includes one or more processors (CPUs), input/output interfaces, network interfaces, and a memory.

The memory may include non-permanent memory, random access memory (RAM), and/or non-volatile memory such as read only memory (ROM) or flash memory (flash RAM) in the computer-readable medium. The memory is an example of a computer-readable medium.

The computer-readable media, including permanent and non-permanent, removable and non-removable media, may store information by any method or technique. The information may be computer-readable instructions, data structures, program modules, or other data. Examples of storage media of a computer include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disc read-only memory (CD-ROM), digital versatile disc (DVD) or other optical storage, magnetic cassette tape, magnetic tape magnetic disk storage or other magnetic storage device, or any other non-transmission medium that may be used to store information that accessible by a computing device. As defined herein, the computer-readable medium does not include a transitory media, such as a modulated data signal and a carrier wave.

It is also noted that the terms “including,” “comprising,” or any other variation thereof, are intended to cover a non-exclusive inclusion, such that a process, a method, an article, or a device that includes a list of elements includes not only those elements but also other elements not expressly listed, or further includes elements inherent to such process, method, article, or device. In the absence of further limitations, elements defined by the statement “include a . . . ” do not exclude the presence of additional same elements in the process, method, article, or device that includes the elements.

The present application may be described in the general context, such as a program module, of computer-executable instructions executable by a computer. Generally, the program module includes routines, programs, objects, components, data structures, etc. that perform particular tasks or implement particular abstract data types. Or the present application may be practiced in a distributed computing environment in which tasks are performed by remote processing devices connected through a communication network. In the distributed computing environment, the program module may be located in local and remote computer storage media, including storage devices.

The various embodiments in the present application are described in a progressive manner. Similar or identical parts across embodiments may be understood through mutual reference. Each embodiment focuses on its differences from the other embodiments. In particular, the system embodiments are generally similar to the method embodiments, so they are described more briefly. For relevant details, please refer to the descriptions of the method embodiments.

Some embodiments of the present application have been described in detail above. The description of the above embodiments merely aims to facilitate understanding of the present application. Many modifications or equivalent substitutions with respect to the embodiments may occur to those of ordinary skill in the art. Thus, these modifications or equivalent substitutions shall fall within the scope of the present application.

What is claimed is:

1. A model processing method, comprising:
obtaining a sample data set of a sample subject, wherein the sample data set comprises a sample image, a sample reference image, and a sample portrait, the sample reference image comprises a background region image, a face region image, and a hairstyle region image, and the sample image is obtained by removing the hairstyle region image from the sample reference image;
inputting the sample data set into a first neural network model for image processing to obtain a predicted portrait of the sample subject, wherein the image processing comprises: performing feature extraction on the sample image and the sample reference image to obtain a first facial feature and a first hairstyle feature of the sample subject; generating a reference portrait of the sample subject based on the first facial feature and the first hairstyle feature; determining a sample portrait feature of the sample subject based on the reference portrait, the first facial feature, and the first hairstyle feature; and generating the predicted portrait based on the sample portrait feature; and
adjusting model parameters of the first neural network model based on the sample image, the predicted portrait, the sample portrait, and the reference portrait to obtain a second neural network model.

2. The model processing method of claim 1, wherein the generating of the reference portrait comprises:
performing dimensionality reduction processing on the first facial feature and the first hairstyle feature to obtain a second facial feature and a second hairstyle feature of the sample subject; and
generating the reference portrait based on the second facial feature and the second hairstyle feature.

3. The model processing method of claim 2, wherein the determining of the sample portrait feature comprises:
performing feature extraction on the reference portrait to obtain a first portrait feature corresponding to the reference portrait;
performing feature fusion processing on the second facial feature, the second hairstyle feature, and the first facial feature to obtain a second portrait feature of the sample subject; and
performing feature fusion processing on the first portrait feature and the second portrait feature to obtain the sample portrait feature.

4. The model processing method of claim 2, wherein the adjusting of the model parameters of the first neural network model comprises:
determining a first loss value, a second loss value and a third loss value of the first neural network model based on the predicted portrait and the sample portrait, wherein the first loss value represents a first difference between the predicted portrait and the sample portrait, the second loss value represents authenticity of image information in the predicted portrait, and the third loss value represents a second difference between a facial feature in the predicted portrait and a facial feature in the sample portrait;
determining a fourth loss value of the first neural network model based on the sample image and the reference portrait, wherein the fourth loss value represents a third difference between a facial feature in the sample image and a facial feature in the reference portrait; and
determining a model loss value of the first neural network model based on the first loss value, the second loss value, the third loss value, and the fourth loss value, and adjusting the model parameters based on the model loss value.

5. The model processing method of claim 1, wherein the first neural network model comprises a first feature extraction module and a second feature extraction module, and
the performing of the feature extraction on the sample image and the sample reference image comprises:
performing feature extraction on the sample image by the first feature extraction module to obtain the first facial feature of the sample subject;
performing feature extraction on the sample reference image by the second feature extraction module to obtain a reference image feature of the sample subject; and
processing the first facial feature and the reference image feature by the first feature extraction module to obtain the first hairstyle feature.

6. A portrait generation method, comprising:
obtaining an image data set of a first subject, wherein the image data set comprises a first image and a first reference image, the first reference image comprises a background region image, a face region image, and a hairstyle region image, and the first image is obtained by removing the hairstyle region image from the first reference image; and
inputting the image data set into a second neural network model for image processing to obtain a portrait of the first subject, wherein the image processing comprises: performing feature extraction on the first image and the first reference image to obtain a facial feature and a hairstyle feature of the first subject; determining a portrait feature of the first subject based on the facial feature and the hairstyle feature; and generating the portrait of the first subject based on the portrait feature.

7. The portrait generation method of claim 6, wherein the second neural network model comprises a first feature extraction module, a second feature extraction module and a feature fusion module,
the performing of the feature extraction on the first image and the first reference image comprises:
performing feature extraction on the first image by the first feature extraction module to obtain the facial feature of the first subject;
performing feature extraction on the first reference image by the second feature extraction module to obtain a reference image feature of the first subject; and
processing the facial feature and the reference image feature by the first feature extraction module to obtain the hairstyle feature of the first subject, and
the determining of the portrait feature of the first subject comprises:
fusing the facial feature and the hairstyle feature by the feature fusion module to obtain the portrait feature of the first subject.

8. An electronic device, comprising: a processor; and a memory storing a computer program executable by the processor to perform operations comprising:
obtaining a sample data set of a sample subject, wherein the sample data set comprises a sample image, a sample reference image, and a sample portrait, the sample reference image comprises a background region image, a face region image, and a hairstyle region image, and the sample image is obtained by removing the hairstyle region image from the sample reference image;
inputting the sample data set into a first neural network model for image processing to obtain a predicted portrait of the sample subject, wherein the image processing comprises: performing feature extraction on the sample image and the sample reference image to obtain a first facial feature and a first hairstyle feature of the sample subject; generating a reference portrait of the sample subject based on the first facial feature and the first hairstyle feature; determining a sample portrait feature of the sample subject based on the reference portrait, the first facial feature, and the first hairstyle feature; and generating the predicted portrait based on the sample portrait feature; and
adjusting model parameters of the first neural network model based on the sample image, the predicted portrait, the sample portrait, and the reference portrait to obtain a second neural network model.

9. The electronic device of claim 8, wherein the generating of the reference portrait comprises:
performing dimensionality reduction processing on the first facial feature and the first hairstyle feature to obtain a second facial feature and a second hairstyle feature of the sample subject; and
generating the reference portrait based on the second facial feature and the second hairstyle feature.

10. The electronic device of claim 9, wherein the determining of the sample portrait feature comprises:
performing feature extraction on the reference portrait to obtain a first portrait feature corresponding to the reference portrait;
performing feature fusion processing on the second facial feature, the second hairstyle feature, and the first facial feature to obtain a second portrait feature of the sample subject; and
performing feature fusion processing on the first portrait feature and the second portrait feature to obtain the sample portrait feature.

11. The electronic device of claim 9, wherein the adjusting of the model parameters of the first neural network model comprises:
determining a first loss value, a second loss value and a third loss value of the first neural network model based on the predicted portrait and the sample portrait, wherein the first loss value represents a first difference between the predicted portrait and the sample portrait, the second loss value represents authenticity of image information in the predicted portrait, and the third loss value represents a second difference between a facial feature in the predicted portrait and a facial feature in the sample portrait;
determining a fourth loss value of the first neural network model based on the sample image and the reference portrait, wherein the fourth loss value represents a third difference between a facial feature in the sample image and a facial feature in the reference portrait; and
determining a model loss value of the first neural network model based on the first loss value, the second loss value, the third loss value, and the fourth loss value, and adjusting the model parameters based on the model loss value.

12. The electronic device of claim 8, wherein the first neural network model comprises a first feature extraction module and a second feature extraction module, and
the performing of the feature extraction on the sample image and the sample reference image comprises:
performing feature extraction on the sample image by the first feature extraction module to obtain the first facial feature of the sample subject;
performing feature extraction on the sample reference image by the second feature extraction module to obtain a reference image feature of the sample subject; and
processing the first facial feature and the reference image feature by the first feature extraction module to obtain the first hairstyle feature.

13. An electronic device, comprising: a processor; and a memory storing a computer program executable by the processor to perform the portrait generation method of claim 6.

14. The electronic device of claim 13, wherein the second neural network model comprises a first feature extraction module, a second feature extraction module and a feature fusion module;
the performing of the feature extraction on the first image and the first reference image comprises:
performing feature extraction on the first image by the first feature extraction module to obtain the facial feature of the first subject;
performing feature extraction on the first reference image by the second feature extraction module to obtain a reference image feature of the first subject; and
processing the facial feature and the reference image feature by the first feature extraction module to obtain the hairstyle feature of the first subject; and
the determining of the portrait feature of the first subject comprises:
fusing the facial feature and the hairstyle feature by the feature fusion module to obtain the portrait feature of the first subject.

15. A non-transitory computer-readable storage medium storing a computer program executable by a processor to perform the model processing method of claim 1.

16. A non-transitory computer-readable storage medium storing a computer program executable by a processor to perform the portrait generation method of claim 6.

17. A computer program product comprising a computer program executable by a processor to perform the model processing method of claim 1.

18. A computer program product comprising a computer program executable by a processor to perform the portrait generation method of claim 6.
